(19) United States
(12) Patent Application Publication
(10) Pub. No.: US 2005/0215678 A1
(43) Pub. Date: Sep. 29, 2005

(54) FLUOROCHEMICAL FREE AQUEOUS COATING COMPOSITIONS AND METHODS OF USE THEREOF

(75) Inventors: Nathan Ludtke, Racine, WI (US); Michael T. Sarkis, Racine, WI (US)

Correspondence Address: S.C. JOHNSON COMMERCIAL MARKETS INC, 8310 16TH STREET, M/S 510, PO BOX 902, STURTEVANT, WI, 53177-0902, US

(73) Assignee: JOHNSONDIVERSEY, INC., Sturtevant, WI (US)

(21) Appl. No.: 10/708,776

(22) Filed: Mar. 24, 2004

(51) Int. Cl. C08K 5/52

(52) U.S. Cl. 524/127; 524/556

(57) ABSTRACT

Fluorochemical free aqueous coating compositions are disclosed. The compositions comprise a film-forming polymer and an organophosphate surfactant. The compositions exhibit superior wetting and leveling properties compared to fluoroaining sulfur based surfactants. Inventive compositions are particularly suitable for use as floor finishes. Methods of makinge aqueous coating compositions are also described.

### BACKGROUND OF INVENTION

1. Field of the Invention

The invention relates to aqueous coating compositions for use as polishes and finishes for surfaces. In particular the invention relates to fluorochemical free aqueous coating compositions containing an organophosphate surfactant, and methods of making and using the same.

2. Background of the Invention

The smoothness, gloss and soil resistance of an aqueous coating composition, especially a floor finish or polish, depends greatly on the choice of surfactants added to the composition. Surfactants reduce the surface tension of the composition and thereby improve the wetting and leveling characteristics of the aqueous coating composition. However, traditional surfactants (e.g., sulfur based surfactants) alone cannot provide adequate wetting and leveling properties. Fluorochemical surfactants have been the most popular wetting and leveling additives used by, e.g., the floor polish industry since the mid-1950s. These agents are typically added in low concentration to aqueous coating compositions along with higher levels of other surfactants. However, increasing concern has arisen that certain fluorochemicals, including fluorochemical surfactants, may constitute potential environmental and health hazards.

For example, perfluorooctanoic acid (PFOA) is undergoing intense scrutiny by the Environmental Protection Agency (EPA) and others. PFOA is used in the manufacture of telomers (small fluorinated polymers), compounds that are widely used as fluorochemical surfactants. The EPA has identified PFOA as a potential persistent, bioaccumulative toxin. Studies have shown that telomers may degrade into PFOA and other perfluorinated compounds, and that PFOA tends to bioaccumulate in certain organisms. Indeed, use of, perfluorooctane sulfonate, a fluorochemical related to PFOA and a precursor to some fluorochemical surfactants, has already been phased out by some companies. Thus, a move to replace fluorochemical surfactants in coatings and polishes has already begun.

Previous fluorochemical free aqueous coatings have generally met with limited success in producing smooth glossy and soil-resistant finishes. Common fluorine free surfactantse.g., fatty acid salts of long chain hydrocarbons and traditional sulfur based surfactants, such as organosulfates, organosulfonates, and esters of sulfosuccinic acid have proven to be far less effective wetting and leveling aids than fluorochemical surfactants. Accordingly, there is a need in the art for aqueous coating compositions which are free of fluorochemical surfactants, but which retain very good wetting and leveling characteristics as well as good soil resistance.

### SUMMARY OF INVENTION

In accordance with the present invention, there are provided aqueous coating compositions including a film-forming polymer and an organophosphate surfactant. The aqueous coating composition is free of fluorochemical surfactant, thus avoiding any potential health and environmental concerns associated with fluorochemicals. The aqueous coating composition is also free of poly(oxy-1,2-ethanediyl), α-(nonylphenyl)-ω-hydroxy-phosphate having about 6 moles of ethyoxylation per mole of nonylphenyl group (e.g. Rhodafac PE510). The coating compositions typically contain 0.001-10 weight percent (wt %) organophosphate surfactant based on the weight of the aqueous coating composition. In the aqueous coating composition, the organophosphate surfactant may exist in salt form as, for example, formed from an alkali or other base. Aqueous coating compositions of the invention may further include additives such as surfactants, polymeric emulsifying agents, coalescing aids, wetting aids, leveling aids, ionic crosslinking agents, wax dispersions and emulsions, defoamers and anti-foamers, antistatic agents, biocides, and the like. In contrast to fluorochemical free coatings containing traditional sulfur based surfactants, inventive compositions exhibit unexpectedly superior wetting and leveling properties to provide a smooth glossy finish. In addition, inventive compositions exhibit better resistance to soiling than aqueous coatings containing sulfur-based wetting and leveling surfactants alone.

In another aspect, the invention provides an aqueous coating composition which includes a film-forming polymer and an organophosphate surfactant having a non-phenolic hydrophobe. Such aqueous coating compositions provide additional benefits by avoiding any potential environmental hazards associated with phenol-containing organophosphate surfactants.

In yet another aspect, the invention provides a fluorochemical free aqueous coating composition that comprises a film-forming polymer which includes polymerized phosphate-containing monomers. Aqueous coating compositions containing such phosphopolymers may contain, but do not require additional organophosphate surfactants to provide good leveling and wetting properties. Thus, the phosphopolymers may be used with traditional sulfur-based surfactants and no other surfactants.

In another aspect, the present invention provides methods of making the aqueous coating compositions described herein and methods of using the compositions. For example, the aqueous coating composition may be produced by forming the film-forming polymer in the presence of the organophosphate surfactant. In this embodiment, the organophosphate surfactant serves as an emulsifier surfactant for preparing the film-forming polymer as well as a leveling and wetting aid. Alternatively, the organophosphate surfactant may simply be mixed with the film-forming polymer. The aqueous coating compositions can be applied as a finish to a variety of surfaces and are particularly suitable for floor finishes and polishes.

### DETAILED DESCRIPTION

### Detailed Description of the Invention

In one aspect, the present invention provides an aqueous coating composition that includes a film-forming polymer and an organophosphate surfactant or mixture of organophosphate surfactants. The aqueous coating composition exhibits good to very good wetting and leveling properties, yet is free of fluorochemical surfactant and poly(oxy-1,2-ethanediyl), α-(nonylphenyl)-ω-hydroxy-phosphate having 6 moles of ethoxylation per mole of nonylphenyl group (also known as polyoxyethylene nonylphenyl ether, branched, phosphate; available from Rhodia as Rhodafac PE510; Chemical Abstracts registry number 51811-79-1). The aqueous coating compositions typically contain about 0.001 to about 10 wt % organophosphate surfactant and in some embodiments from about 0.01 to about 4 wt % based on the weight of the aqueous coating composition. The aqueous coating compositions typically contain 0.1 to about 70 wt % film-forming polymer(s) based on the weight of the aqueous coating composition. Other embodiments of the coating compositions contain from 0.1 to about 60 wt %, 1 to about 50 wt %, 5 to about 50 wt %, or 10 to about 40 wt % film-forming polymer(s).

The organophosphate surfactant includes an ionizable phosphate group and a hydrophobe and is optionally ethoxylated. The organophosphate surfactant is therefore a monoester, diester, or a mixture of monoester and diester of phosphoric acid. Because the phosphate group is ionizable, organophosphate surfactants may be used in compositions of the invention as neutralized salts or as free acids. When added as a free acid to aqueous coating compositions having free alkali and/or other metal cations, the phosphoric acid groups of the organophosphate surfactant may be neutralized or sequestered. Common alkali components in the aqueous coating composition include, but are not limited to, sodium hydroxide, potassium hydroxide, calcium hydroxide, and ammonia (as ammonium hydroxide), or mixtures thereof. A typical metal in the aqueous coating composition includes, but is not limited to, multivalent metals such as zinc (e.g., from zinc oxide or zinc ammonium carbonate) and calcium (e.g., from calcium oxide or calcium hydroxide). Organophosphate surfactant neutralized salts can be made, for example, from bases selected from alkali metals, alkali earth metals, or organic amines. Suitable bases include those, for example, having lithium, sodium, potassium, rubidium, cesium, beryllium, magnesium, calcium, strontium, and barium. Suitable amines include, for example, both volatile and non-volatile amines such as ammonia (as ammonium hydroxide), triethylamine, amino2-dimethylamino-2-methyl-1-propanol, ethanolamine, and dimethylethanol amine, and the like. Mixtures of amines and/or fixed alkali bases may be employed. Typically, the neutralization salts are selected from alkali metals or amines for optimal wetting and leveling properties and for good emulsion polymer physical properties. While the organophosphate surfactants may exist at anywhere from 0 to 100 percent neutralization, 10 to 100 percent neutralization is suitable.

The hydrophobe of the organophosphate surfactant is a hydrophobic organic moiety. Suitable organic moieties are typically unsubstituted, but may be substituted to the extent that the organophosphate retains its surfactant activity. Organophosphate surfactants having non-phenolic hydrophobes, are particularly suitable. Non-phenolic hydrophobes do not contain phenoxy or phenol groups, and may improve the safety of the aqueous coating composition by avoiding potential environmental hazards associated with phenolic hydrophobes. Accordingly, in some embodiments, there are provided aqueous coating compositions that include a film-forming polymer and an organophosphate surfactant, the surfactant comprising an ionizable phosphate group and a non-phenolic hydrophobe.

Suitable hydrophobes further include substituted or unsubstituted alkyl groups of 1 to 40 carbon atoms. In some embodiments, the alkyl groups have from 1 to 24 carbon atoms or from 4 to 24 carbon atoms. Alkyl groups are saturated hydrocarbons that may be straight, branched or cyclic. Thus, straight chain alkyl groups include methyl, ethyl, propyl, butyl, pentyl, hexyl, heptyl, octyl, nonyl, decyl, undecyl, dodecyl, tridecyl and the like. Branched chain alkyl groups include —CH(CH₃)₂, —CH(CH₃)(CH₂CH₃), —CH(CH₂CH₃)₂, —C(CH₃)₃, —C(CH₂CH₃)₃, —CH₂CH(CH₃)₂, —CH₂CH(CH₃)(CH₂CH₃), —CH₂CH(CH₂CH₃)₂, —CH₂CH(CH₂CH₃)CH₂CH₂CH₂CH₃, —CH₂C(CH₃)₃, —CH₂C(CH₂CH₃)₃, —CH(CH₃)CH(CH₃)(CH₂CH₃), —CH₂CH₂CH(CH₃)₂, —CH₂CH₂CH(CH)(CH₂CH₃), —CH₂CH₂CH(CH₂CH₃)₂, —CH₂CH₂C(CH₃)₃, —CH₂CH₂C(CH₂CH₃)₃, —CH(CH₃)CH₂CH(CH₃)₂, CH(CH₃)CH(CH₃)CH(CH₃)₂, —CH(CH₂CH₃) H(CH₃)CH(CH₃)(CH₂CH₃), —(CH₂)₇CH(CH₃), and others. Cyclic alkyl groups include groups such as cyclopropyl, cyclobutyl, cyclopentyl, cyclohexyl, cycloheptyl, and cyclooctyl and such rings substituted with straight and branched chain alkyl groups as defined above. Alkyl groups also includes polycyclic alkyl groups such as, but not limited to, adamantyl, norbornyl, and bi-cyclo[2,2,2]octyl and such rings substituted with straight and branched chain alkyl groups as defined above. Thus, the phrase “unsubstituted alkyl” includes primary alkyl groups, secondary alkyl groups, and tertiary alkyl groups. Unsubstituted alkyl groups may be bonded to oxygen in the ethoxylated moiety or the phosphate moiety. Suitable hydrophobes include but are not limited to butyl, hexyl, octyl, nonyl, decyl, undecyl, dodecyl, tridecyl, cetyl (hexadecyl), 2-ethylhexyl, isostearyl, and isodecyl.

Substituted alkyl groups are unsubstituted alkyl groups in which one or more bonds to a carbon or hydrogen are replaced by a bond to substituents such as chlorine, bromine, iodine (but not fluorine), hydroxyl, alkoxy, aryloxy, thiol, thioalkyl, cyano, amine, secondary and tertiary amines containing alkyl, aryl, arylalkyl and the like, carbonyl, carboxyl, ester, amide, secondary and tertiary amides containing alkyl, aryl, arylalkyl, and the like.

Suitable organophosphate surfactant hydrophobes also include substituted or unsubstituted aryl or substituted or unsubstituted arylalkyl. Typically such groups have from 6 to 40 carbon atoms. In some embodiments, aryl and arylalkyl groups have from 6 to 24 carbon atoms. Unsubstituted aryl refers to aromatic hydrocarbons. Exemplary aryl groups include, but are not limited to, phenyl, biphenyl, and naphthyl. Substituted aryl has the same meaning with respect to unsubstituted aryl that substituted alkyl has respect to unsubstituted alkyl. However, a substituted aryl group also includes aryl groups in which one of the aromatic carbons is bonded to one of the non-carbon or non-hydrogen atoms described above and also includes aryl groups in which one or more aromatic carbons of the aryl group is bonded to a substituted or unsubstituted alkyl group as defined herein. Hence, substituted aryl includes, for example, tolyl and chlorophenyl. Unsubstituted arylalkyl refers to unsubstituted alkyl groups as defined above in which a hydrogen or carbon bond of the unsubstituted alkyl group is replaced with a bond to an aryl group as defined above. Exemplary arylalkyls include benzyl, phenethyl, and dodecylphenyl among others. The phrase “substituted arylalkyl” has the same meaning with respect to unsubstituted arylalkyl groups that substituted aryl groups had with respect to unsubstituted aryl groups. Thus, substituted arylalkyls include octylphenol, nonylphenol, and the like.

Organophosphate surfactants useful in inventive compositions can be alkoxylated, i.e., can contain one or more alkylene oxide moieties. The alkoxylation may, for example, link the phosphate group to the hydrophobe. Suitable alkylene oxide moieties contemplated in the practice of the invention include ethylene oxide, propylene oxide, and the like. Typically, organophosphate surfactants containing up to 50 equivalents of alkoxylation (i.e., 50 moles of alkylene oxide per mole of surfactant) retain good to very good wetting and leveling properties. In some embodiments, organophosphate surfactants contain up to 10 equivalents of alkoxylation.

Organophosphate surfactants can be synthesized from optionally ethoxylated alcohols, according to techniques well known in the art. Two basic phosphating processes involve reacting the alcohol with either phosphorous pentoxide or polyphosphoric acid. Commercial organophosphate surfactants display variable compositions depending upon the method of manufacture. For example, the polyphosphoric acid phosphating process generally leads to high levels of monoester and high levels of phosphoric acid relative to the phosphorous pentoxide phosphating process. Conversely, the phosphate pentoxide phosphating process generally leads to higher levels of diester and lower levels of phosphoric acid relative to the polyphosphoric acid phosphating process. Despite the variability in composition, it is clear that as a class, organophosphate surfactants produce far superior wetting and leveling properties in fluorochemical free aqueous coating compositions compared to sulfur based surfactants fluorochemical free compositions (compare Tables 1 and 2 in the Examples).

For example, organophosphate surfactants containing either high monoester or high diester content can yield surfactants producing good to very good wetting and leveling properties. Consequently, the diester content of the organophosphate surfactants may range anywhere from 0 to 100 wt % of the organophosphate surfactant. Organophosphate surfactant diester content in some embodiments is up to about 80 wt % and in other embodiments is up to about 60 wt %. In still other embodiments, the organophosphate surfactant monoester content is up to about 100 wt %, up to about 90 wt %, or up to about 80 wt %.

Similarly, organophosphate surfactants containing free phosphoric acid as a side product of the surfactant production process can yield surfactants that have very good to good wetting and leveling properties. Typically, the organophosphate surfactant will contain from 0 to 20 wt % phosphoric acid or its salts or from 0 to 10 wt % phosphoric acid or its salts.

Organophosphate surfactants may also contain free nonionic surfactant as a side product of the surfactant production process. Nonetheless, such organophosphate surfactants retain very good to good wetting and leveling properties. Consequently, the nonionic surfactant content of the organophosphate surfactant may range anywhere from 0 to about 50 percent and in some embodiments, from 0 to about 30 percent by weight.

The film-forming polymers are typically emulsion polymers formed from ethylenically unsaturated monomers. Suitable emulsion polymers include acrylic, vinyl (including styrenyl), or vinyl/acrylic polymers. Vinyl/acrylic emulsion polymers such as styrene/acrylic emulsion polymers are particularly suitable. In addition, urethane polymers may be used alone or in a blend with polymers formed from ethylenically unsaturated monomers such as acrylic, vinyl (including styrenyl), or vinyl/acrylic polymers. The dry weight of emulsion polymer(s) can make up anywhere from about 0.1 to about 70% of the aqueous coating composition. In other embodiments the dry weight of emulsion polymer(s) constitute from 0.1 to about 60 wt %, 1 to about 50 wt %, 5 to about 50 wt %, or 10 to about 40 wt % of the aqueous coating composition.

The preparation of emulsion polymers is well known to those skilled in the art. Generally such emulsion polymers are prepared with ethylenically unsaturated monomers, initiators, surfactants or polymeric emulsifying agents, alkali, and water. Vinyl/acrylic polymers used in the practice of the invention typically are produced from monomer mixtures having from 0 to about 70 wt % and, in some embodiments, from about 20 to about 60 wt % of a vinyl monomer such as styrene and α-methylstyrene. The acrylic monomers typically comprise about 20 to about 100 wt % of the monomer mixture, and in some embodiments about 40 to about 80 wt %. Exemplary acrylic monomers include but not limited to acrylic acid, methacrylic acid, methyl acrylate, ethyl acrylate, 2-ethylhexyl acrylate, methyl methacrylate, butyl acrylate, isobutyl methacrylate, benzyl methacrylate, hydroxyethyl methacrylate, glycidyl methacrylate, and the like.

Where the aqueous coating composition is to be used in as a floor finish, the majority of the polymer(s) used in the composition will usually contain some acid monomer to produce films removable with conventional floor finish stripping chemicals. When present, the acid monomer typically comprises up to about 25 wt % of the monomer mixture, and in some embodiments about 1 to about 20 wt %, or about 5 to about 20 wt %. Suitable acid monomers include alkenoic acids having 3 to 6 carbon atoms, such as acrylic acid, methacrylic acid, crotonic acid, maleic acid, itaconic acid, fumaric acid or mixtures thereof. Methacrylic acid is particularly suitable for use in the preparation of film-forming polymers of the invention.

Alternatively, inventive compositions include film-forming polymers comprising polymerized phosphate-containing monomers. Such phosphopolymers can be used in fluorochemical free aqueous coating compositions to achieve desirable wetting and leveling properties without additional organophosphate surfactant, but may also be used with organophosphate surfactants. Like the organophosphate surfactants described herein, the phosphate containing monomers contain an ionizable phosphate group. Exemplary monomers include phosphate esters of polyethylene glycol monomethacrylate and phosphate esters of polypropylene glycol monomethacrylate. Typically, when present, phosphate containing monomers may comprise up to about 20 wt % of the film forming polymer. In some embodiments, aqueous coating compositions include film-forming polymer(s), wherein the film-forming polymer(s) comprises polymerized phosphatemonomers. Such aqueous coating compositions may further include OLE_LINKlone or more additives selected from the group consisting of surfactants, polymeric emulsifying agents, coalescing aids, wetting aids, leveling aids, ionic crosslinking agents, wax dispersions and emulsions, defoamers and antifoamers, antistatic agents, and biocides-OLE_LINK1. However, aqueous coating compositions including film-forming polymers comprising polymerized phosphate-containing monomers may exclude one or more additives selected from the group consisting of surfactants, polymeric emulsifying agents, coalescing aids, wetting aids, leveling aids, ionic crosslinking agents, wax dispersions and emulsions, defoamers and antifoamers, antistatic agents, and biocides.

The emulsion polymer(s) employed in the floor finish composition of this invention is generally a styrene/acrylic or acrylic copolymer having a glass transition temperature (Tg) in degrees centigrade (using the Fox calculation method) from 0° C. to 110° C., in some embodiments from 10° C. to 100° C. The specified Tg can come from one polymer composition or be an average from a blend of one or more polymer compositions.

Although emulsion polymers can be prepared using a wide range of surfactants (including anionic, cationic, & nonionic types) and polymeric emulsifying agents (e.g., protective colloids such as alkali soluble or dispersible resins), it is possible to make emulsion polymers only based on surfactants or only based on polymeric emulsifying agents or with mixtures of both. Typical anionic surfactants are alkyl sulfonates, alkylaryl sulfonates, alkyl sulfates, sulfates of hydroxyalkanols, alkyl and alkylaryl disulfonates, sulfonated fatty acids, sulfates and sulfonates of polyethoxylated alkanols and alkylphenols, as well as esters of sulfosuccinic acid. Organophosphate surfactants as described herein are particularly advantageous for use because these surfactants may serve as both the emulsion polymer surfactant and the leveling and wetting aid. In some embodiments, aqueous coating compositions include both organophosphate surfactants and alkali-soluble or dispersible resins (e.g., polymeric emulsifying agents) along with the emulsion polymer.

Alkali-soluble or dispersible resins (e.g., polymeric emulsifying agents) suitable for use in these inventive aqueous coating compositions can be introduced into the coating composition as an individual ingredient, as protective colloids used to make emulsion polymers, or from both sources. Suitable alkali-soluble or dispersible resins include but are not limited to, styrene/acrylic resins, acrylic resins, styrene-maleic anhydride resins, rosin/maleic anhydride adducts which are condensed with polyols, polycarboxypolyamide resins, styrene/acrylic adducts which are condensed with step addition or ring opened polymers, and the like. The alkali-soluble or dispersible resins typically have a weight average molecular weight from about 500 to about 200,000 and in some embodiments from about 500 to about 100,000, from about 1,000 to about 30,000, or from about 4,000 to about 20,000. The resins are often used as a conventional resin cut, which is an aqueous solution of the resin with an alkaline substance such as ammonia (ammonium hydroxide), alkali metal hydroxides, or mixtures of such, for example. The alkali soluble or dispersible resin is typically employed in amounts from 0 to about 40 wt % and in some embodiments in amounts from 0 to about 20 wt %, from about 0.1 to about 10 wt % based on the weight of the aqueous coating composition.

The aqueous coating composition can also contain ionic crosslinking agents such as metals, metal complexes, or mixtures of two or more thereof. Ionic crosslinking agents are typically employed in amounts from 0 to about 3 wt % based on the weight of the aqueous coating composition. Suitable polyvalent metals may also be combined with monovalent metals such as but not limited to lithium, sodium, potassium, rubidium, and cesium, for example. Suitable polyvalent metals include but are not limited to beryllium, cadmium, copper, calcium, magnesium, zinc, zirconium, barium, strontium, aluminum, bismuth, antimony, lead, cobalt, iron, nickel, and the like. Although the metal compound can be added to the aqueous coating composition in dry form such as a powder, it is usually added as a solution. The metal compound is typically a metal complex, a metal salt of an organic acid, or a metal chelate. The ammonia and amine complexes of these metals are particularly useful because of their high solubility. Amines capable of complexing many metals include, for example, ammonia, monoethanolamine, diethylaminoethanol, and ethylenediamine. Polyvalent metal complexes and salts of organic acids are typically soluble in an alkaline pH range. Anions of organic acids include acetate, formate, carbonate, glycolate, octanoate, benzoate, gluconate, oxalate, lactate, and the like. Polyvalent metal chelates where the ligand is a bidentate amino acid such as glycine or alanine can also be used.

Zinc and calcium are polyvalent metal ions typically used in inventive compositions. Suitable polyvalent metal compounds include zinc oxide, zinc acetate, calcium acetate, zinc glycinate, calcium glycinate, zinc carbonate, calcium oxide, calcium hydroxide, calcium carbonate, zinc benzoate, zinc salicylate, zinc glycolate, and calcium glycolate. In some applications, a fugitive ligand such as ammonia is used. A ligand is considered fugitive if at least a portion of the ligand tends to volatilize as the aqueous coating composition dries to form a film on the surface.

Waxes may be added to inventive aqueous coating compositions for safety to control the slip properties of the resulting finish, to improve the gloss thereof and to allow the finish to be buffed or burnished. Suitable wax dispersions or emulsions include those of vegetable, animal, synthetic and/or mineral origin, and mixtures thereof. Representative waxes include but are not limited to, for example, carnauba, candelilla, lanolin, stearin, beeswax, polyethylene, oxidized polyethylene, polypropylene, oxidized polypropylene, copolymers of ethylene and acrylic acid, copolymers of ethylene and maleic anhydride, copolymers of ethylene and acrylic esters, copolymers of ethylene and vinyl acetate, copolymers of propylene and maleic anhydride, terpolymers of ethylene and vinyl acetate and acrylic acid, hydrogenated coconut oil or soybean oil, and the mineral waxes such as paraffin, montan, or ceresin. Typically wax dispersions or emulsions based on polyethylene or polypropylene are used in the aqueous coating composition. Exemplary polyethylene wax dispersions include AC-316 (oxidized polyethylene) and AC-540 (copolymer of ethylene and acrylic acid) from Honeywell Specialty Chemicals, Morristown, N.J. Exemplary polypropylene wax dispersions include Epolene E-43 from Eastman Chemical, Kingsport, Tenn. Wax emulsions and dispersions suitable for use may include an organophosphate surfactant(s) that acts as the dispersing and emulsifying agent for preparing the wax emulsion or dispersion as well as a wetting and leveling aid. The waxes typically range from 0 to about 40 wt % and in some embodiments from about 0 to about 20 wt %, or from about 0.1 to about 10 wt % based on the weight of the aqueous coating composition. In some embodiments, aqueous coating compositions include both organophosphate surfactants, a wax (one or more wax dispersions or emulsions), along with the film forming emulsion polymer.

Suitable coalescing aids include organic solvents that can be totally, partially, or sparingly soluble, or insoluble in water. Exemplary coalescing aids include but are not limited to glycol ether based solvents based on ethylene or propylene glycol such as ethylene glycol, propylene glycol, diethylene glycol ethyl ether, dipropylene glycol methyl ether, diethylene glycol methyl ether, diethylene glycol propyl ether, diethylene glycol butyl ether, ethylene/diethylene glycol 2-ethylhexyl ether, ethylene glycol phenyl ether, dipropylene glycol propyl ether, dipropylene glycol butyl ether, propylene glycol phenyl ether, and the like. Additional suitable coalescing aids include pyrrolidone based solvents such as 2-pyrrolidone, N-methyl-2-pyrrolidone, N-octyl-2-pyrrolidone, N-dodecyl-2-pyrrolidone, and the like. Such solvents may be used alone or as blends with other solvents or coalescing aids. Solvents used as coalescing aids may be present from about 0 to about 20 wt % of the aqueous coating composition or from about 0.1 to about 15 wt %.

Coalescing aids known in the art as polymeric plasticizers, and also used routinely, include but are not limited to phosphate based solvents like tributoxyethyl phosphate, triethyl phosphate, tributyl phosphate, tricresyl phosphate, triphenyl phosphate, and the like as well as glycol ether dibenzoate solvents based on ethylene or propylene glycol such as but not limited to propylene glycol dibenzoate, dipropylene glycol dibenzoate, polypropylene glycol dibenzoate, ethylene glycol dibenzoate, diethylene glycol dibenzoate, polyethylene glycol dibenzoate, neopentyl glycol dibenzoate, and the like as well as isodecyl benzoate, dipropylene glycol monomethyl ether benzoate, 2,2,4-trimethyl-1,3-pentanediol diisobutyrate, and phthalate based solvents such as but not limited to dibutyl phthalate, butyl benzyl phthalate, diethyl phthalate, and the like to mention a few. Tributoxyethyl phosphate is particularly suitable because it enhances wetting and leveling of the aqueous coating composition as well as coalescence. Plasticizers may be used alone or in blends with other plasticizers or coalescing aids. Plasticizers typically range from about 0 to about 15 wt % of the aqueous coating composition or from about 0.1 to about 10 wt %. The level of coalescing aid used in a particular aqueous coating composition will depend upon the overall polymer Tg (or average Tg if more than one polymer) and is sufficient to produce a clear, glossy, well-coalesced film. Higher amounts of coalescing aid may be used to produce desired properties for specific applications as known to those skilled in the art.

Surfactants other than organophosphate surfactants may be added to the aqueous coating composition as wetting aids, leveling aids, anti-foamers, and defoamers as well as for other purposes. Suitable surfactants for wetting or leveling aids include anionic surfactants, cationic surfactants, nonionic surfactants, and mixtures of two or more thereof. Thus, aqueous coating compositions of the invention may include but not limited to, for example, surfactants such as organosulfates, organosulfonates, mono and diester organosulfosuccinates, polysiloxanes, polyether modified polysiloxanes, acetylene base surfactants, and nonionic surfactants such as examples of which are presented in Tables 3 and 4 of the Examples. However, fluorochemical surfactants are no longer required as wetting and leveling aids and may be excluded from aqueous coating compositions of the invention. Additional surfactants that may be added include the alkali metal and amine salts of higher fatty acids having, for example, 12 to 18 carbon atoms such as salts of tall oil fatty acid. Suitable polymeric emulsifying agents may also be added such as disclosed herein. Anti-foaming agents that can be used in the practice of the invention include emulsified oils, fatty acids, and silicon-containing emulsions or polymers. Anti-static agents that can be used include, e.g., quaternary ammonium salts. Surfactants other than organophosphate surfactants may be used at up to 2 wt % of the aqueous coating composition. Biocides help minimize the formation of molds or mildew in the coating and may be added as necessary. Biocides include bacterocides and bacteriostats. Exemplary biocides include isothiazolinones such as Kathon CG/ICP from Rohm and Haas. When present, the amount of biocide in the aqueous coating composition is kept to a minimum, typically 1 wt % or less of the composition.

In one embodiment the fluorochemical free aqueous coating composition includes
0.001 to 10 wt % organophosphate surfactant(s);
0.1 to 70 wt % film-forming polymer(s);
30 to 99 wt % water;
up to 3 wt % ionic crosslinking agent(s);
up to 2 wt % surfactant(s) other than organophosphate surfactant;
up to 40 wt % polymeric emulsifying agent(s); up to 35 wt % coalescing aid(s); and
up to 40 wt % wax(es);
   based on the total weight of the composition. The composition does not include poly(oxy-1,2-ethanediyl), α-(nonylphenyl)-ω-hydroxy-phosphate.

In another aspect, the present invention provides methods of making the aqueous coating compositions as described herein. For example, the methods include forming the filmpolymer in the presence of the organophosphate surfactant. In this embodiment, the organophosphate surfactant serves as an emulsifier surfactant for the film-forming emulsion polymer. This method avoids diluting or decreasing the wetting and leveling benefits produced by the organophosphate surfactant as would occur if a traditional sulfur based surfactant was used as the emulsifier surfactant. The method further comprises mixing the film-forming polymer and the organophosphate surfactant with one or more additives selected from the group consisting of surfactants, polymeric emulsifying agents, coalescing aids, wetting aids, leveling aids, ionic crosslinking agents, wax dispersions and emulsions, defoamers and antifoamers, antistatic agents, and biocides. Alternatively, the aqueous coating composition may be prepared by the method comprising mixing the film-forming polymer with the organophosphate surfactant.

In another aspect, the invention provides a method of polishing a surface by applying to a surface the aqueous coating composition described herein. The aqueous coating composition may be applied with a mop, sponge, roller, cloth, brush, pad, or any other suitable tools such as T-bar applicators, application dispensing tools, or spray application equipment. The aqueous coating composition can be applied to a variety of surfaces including floor, wall, ceiling, countertop and bathroom surfaces. The surfaces can be fibers, metal, plastic, wood, stone, brick, glass, cement, concrete, ceramic, masonite, drywall, plaster, plastic and the like. Bathroom surfaces include countertops, shower stalls, toilets and urinals. Typically, the aqueous coating composition is applied to a floor. The floor surface can be wood, vinyl, linoleum, terrazzo, marble, granite, rubber, asphalt, asbestos, concrete, ceramic and the like.

Typically, one or more coats of the aqueous coating composition are applied to a surface. For example, 1 to 30, or even 100 or more coats may be applied to a surface to achieve a high wet look gloss and or high burnishability. Coatings may be applied consecutively or at different times to achieve coating film thickness. Consequently, the aqueous coating composition must be capable of wetting both the surface and coatings formed from the aqueous coating composition. The surface tension of the aqueous coating composition is typically adjusted to be lower than the surface energy of the substrate surface. For application to flooring substrates, the surface tension of the aqueous coating composition is adjusted by the addition of the organophosphate surfactant to be less than 32 dynes/cm and, typically, about 25 to about 30 dynes/cm. Inventive aqueous coating compositions maintain particularly good wetting and leveling properties after application of the first coat in contrast to fluorochemical free compositions using sulfur-based surfactants alone (compare Tables 1 and 2 in the Examples).

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,”0 “less than,” and the like include the number recited and refer to ranges which can be subsequently broken down into subranges as discussed above.

All patents and publications described herein are incorporated by reference in their entirety for all purposes.

### EXAMPLES

The following non-limiting examples serve to further illustrate advantages of the disclosed invention.

Organophosphate surfactants were evaluated in a model floor finish composition versus several industrial standard surfactant classes including sulfates, sulfonates, diphenyl disulfonates, and sulfosuccinates. As a class of surfactants, the organophosphate surfactants provided much better wetting and leveling properties than any of the sulfur based surfactants. In these experiments all of the sulfur based surfactant containing floor finish examples and all of the organophosphate based surfactant containing floor finish examples were tested against one organophosphate surfactant, Rhodafac RS410 Na+ [sodium salt of polyoxyethylene (3 moles ethylene oxide, EO) tridecyl ether phosphate; all Rhodafac surfactants available from Rhodia. Inc., Marietta Ga.] as a comparative control. To evaluate the effect the surfactant has on the wetting and leveling properties of the floor finish, each example was prepared using only one surfactant for comparative purposes. To achieve this each example floor finish composition contained a styrene/acrylic emulsion polymer prepared by using only one surfactant. Emulsion polymer examples were prepared using the following model composition and by replacing the dry weight of the Rhodafac RS410 surfactant with the same dry weight of other surfactant types. Water levels and alkali types and amounts used in the emulsion polymer compositions containing other surfactants had to be adjusted to accommodate the percent solids of the surfactant as well as the type and amount of alkali used (if needed) to prepare the example. All emulsion polymer examples in this invention were prepared by the following process and using the following model styrene/acrylic emulsion polymer composition.

### Preparation of A Styrene/Acrylic Emulsion Polymer For Use In An Aqueous Coating Composition: Emulsion Polymer Example #1 (EP#1)

A two liter four-necked round bottom flask was equipped with a heating/cooling system means to control and change temperature, variable rate anchor paddle agitation, and mechanical pumps as a means for metering monomers. To the two liter flask was charged 633 deionized (DI) water, 14 of Rhodafac RS410 (100%), and 3.15 of a 50% w/w water solution of NaOH. This amount of NaOH approximates about a 75% degree of neutralization of the Rhodafac RS410 and yielded an initial solution pH@7.0-7.5. These contents were mixed at 180 revolutions per minute (rpm) and heated to 80° C. At 80° C., 2.45 of ammonium persulfate dissolved in 24.5 DI water was added to the flask and the mixture was held at 80° C. for 3 minutes. An internal contents temperature of 80° C. was maintained throughout the entire reaction procedure by means of the heating/cooling system. After the 3 minute hold period, the free radical emulsion polymerization process was initiated by feeding a homogeneous mixture of (122.5 styrene, 24.5 methyl methacrylate, 115.5 butyl acrylate, 45.5 methacrylic acid, and 42 alpha methyl styrene) monomers to the flask contents uniformly over a period of 65 minutes. When the monomer feed was completed, the contents was held at 80° C. for 90 minutes to complete the polymerization process. After the 90 minute hold period, the flask contents was cooled to 40° C. and 1.575 of ammonium hydroxide (28 % w/w water solution of ammonia) dissolved in 15.75 DI water was added to the contents over a period of 5 minutes. When the final emulsion polymer was completely cooled to room temperature, the emulsion polymer physical properties were evaluated to be: Non-Volatiles (NV)=35.1%, pH=5.6, Brookfield Viscosity (BFV)=13 centipoise (LVF 60 rpm/spindle #1 at 25° C), Particle Size (PS)=65 nm (Brookhaven BI-90 PS Analyzer), Percent Coagulum <0.01% (325 mesh screen), Residual Monomer=Non-detectable by gas chromatography (5 ppm detectable limit).

This emulsion polymer example using Rhodafac RS410 sodium salt (Example EP#1) and all the other emulsion polymer surfactant examples that were used to prepare floor finish compositions for comparative wetting and leveling evaluations can be found below in Tables 1 and 2. Four of the emulsion polymer example compositions prepared containing Rhodafac RS410 sodium salt and listed in Table 1 vary from the emulsion polymer example model prepared in Example EP#1. One of the emulsion polymer examples used a higher degree of Rhodafac RS410 neutralization (Emulsion Polymer Example EP#39 used 4.250% NaOH/14 RS410) and one of the emulsion polymer examples used a lower degree of Rhodafac RS410 neutralization (Emulsion Polymer Example EP#40 used 2.150% NaOH/14 RS410) than used in Emulsion Polymer Example EP#1. By comparison, the emulsion polymer example prepared in Emulsion Polymer Example EP#1 used a Rhodafac RS410 degree of neutralization of 3.1550% NaOH/14 RS410 (i.e. 0.22550% NaOH/g RS410). The other two emulsion polymer examples prepared and listed in Table 1 used the same Rhodafac RS410 degree of neutralization as in the emulsion polymer example prepared in Emulsion Polymer Example EP#1 (i.e. 0.22550% NaOH/g RS410) but one emulsion polymer example used 50% less Rhodafac RS410 (Emulsion Polymer Example EP#41 used 1.57550% NaOH/7 RS410) and the other emulsion polymer example used 75% less Rhodafac RS410 (Emulsion Polymer Example EP#42 used 0.7950% NaOH/3.5 RS410) than used in Emulsion Polymer Example EP#1.

### Preparation of A Fluorochemical Free Floor Finish Composition: Floor Finish Example #1 (FF#1)

A floor finish composition consisting of a organophosphate surfactant (sodium salt of Rhodafac RS410) containing styrene/acrylic emulsion polymer prepared in Example EP#1 was prepared as described in this example. All floor finish examples in this invention were prepared by the following process and using the following model floor finish composition.

A 300 mL vessel equipped with an agitation means was charged 71.7 DI water, 8 Carbitol DE (diethylene glycol monoethyl ether, from Dow Chemical, Midland, Mich.), and 18.1 of a 25% w/w water solution of a styrene/acrylic resin (Acid Number @217, Glass Transition Temperature (Tg) @95° C., Weight Average Molecular Weight (Mw) @5500, from Johnson Polymer, Racine, Wis., as described in U.S. Pat. No. 4,529,787). The vessel contents were mixed for 5 minutes at room temperature in order to ensure homogeneity. Agitation was used continuously throughout the floor finish blending process. After the 5 minute mixing hold period, 78 of a 35%w/w styrene/acrylic emulsion polymer (as prepared in emulsion polymer Example EP#1) was added uniformly over 1 minute to the vessel contents and then held for a period of 5 minutes. After the 5 minute mixing hold period, 5.3 of zinc ammonium carbonate (as a 15% w/w water solution of zinc oxide) from Hydrite Chemical, Milwaukee, Wis. was added uniformly over 2 minutes to the vessel contents and then held for a period of 30 minutes. After the 30 minute mixing hold period, 4 of Ektasolve EEH (ethylene/diethylene glycol 2-ethylhexyl ether) from Eastman Chemical, Kingsport, Tenn. was added uniformly over 1 minute to the vessel contents and then held for a period of 5 minutes. After the 5 minute mixing hold period, 2.4 of KP-140 (tributoxyethyl phosphate) from Great Lakes Chemical, West Lafayette, Ind. was added uniformly over 1 minute to the vessel contents and then held for a period of 15 minutes. After the 15 minute mixing hold period, 12.6 g of Epolene E-43 Wax Dispersion (as a 40% w/w water dispersion of Epolene E-43 (polypropylene based), E-43 Wax from Eastman Chemical, Kingsport, Tenn., E-43 Wax Dispersion from Johnson Diversey, Racine, Wis.) was added uniformly over 1 minute to the vessel contents and then held for a period of 60 minutes. The floor finish composition was then allowed to age for one day at room temperature before coating on vinyl composition tile (VCT) and evaluating the wetting and leveling properties of the floor finish. The resulting floor finish physical properties were evaluated to be: NV=20.1%, pH=8.8, BFV=5.5 centipoise (LVF 60 rpm/spindle #1 at 25° C.), Percent Coagulum <0.01% (325 mesh screen). The wetting and leveling properties of this finish example on VCT was rated to have very good to good wetting and leveling properties on the first and sixth coat.

### Evaluation of Fluorochemical Free Floor Finish Examples

Fluorochemical free floor finish example 1 (Example FF#1) using the emulsion polymer containing Rhodafac RS410 sodium salt (Example EP#1) and all the other floor finishes prepared from all the other emulsion polymer surfactant examples were tested for comparative wetting and leveling evaluations can be found below in Tables 1 and 2. All fluorochemical free floor finish examples in this invention were tested for comparative wetting and leveling properties versus Example FF#1 in the following manner using the following coating and rating procedures.

### Floor Finish Coating Application To Vinyl Composition Tile Flooring Procedure And Floor Finish Coating Rating Procedure

To coat the vinyl composition tile (VCT) flooring a Johnson Wax Applier (push pad mop) with a 2″ by 8″ cotton pad applier mop head was used. The VCT flooring was completely stripped of any floor finish prior to application by using a 1:4 solution of Prostrip floor finish stripper, from Johnson Diversey, Racine, Wis., in water. The VCT flooring was rinsed thoroughly after stripping with water and allowed to dry before coating application commenced. An area of 5 square feet (12″ by 60″) was coated with each fluorochemical free floor finish example. Tests consisted of 6 coat applications. Each coat was applied by placing the floor finish in the middle of the test area and evenly spreading out the floor finish uniformly over the test floor area. Floor Finish example FF#1 was applied in each sample set as a comparative control. The first coat application used 16 milliliters (mL) of fluorochemical free floor finish example because the cotton pad mop head applier was dry. Subsequent coats (Coats #2-6) used 12 mL of fluorochemical free floor finish example. Coatings were allowed to dry 30 minutes before the next coat application was carried out. About 15 minutes after each coat, a wetting and leveling rating was assessed (Examples Scored) for each fluorochemical free floor finish example. A rating (Scoring) system as explained below was employed.

Definition of wetting and leveling rating (Scoring) system used to assess the wetting and leveling properties of fluorochemical free floor finish examples.

Leveling & Wetting Scoring System

| Score | Definition |
|---|---|
| 10 | Excellent to Very Good Wetting and Leveling |
| 9 | Very Good Wetting and Leveling |
| 8 | Very Good to Good Wetting and Leveling |
| 7 | Good Wetting and Leveling |
| 6 | Good to Fair Wetting and Leveling |
| 5 | Fair Wetting and Leveling |
| 4 | Fair to Poor Wetting and Leveling |
| 3 | Poor Wetting and Leveling |
| 2 | Poor to Very Poor Wetting and Leveling |
| 1 | Very Poor Wetting and Leveling |

TABLE 1

| Organo Phosphate Ester Surfactant Fluorochemical Free Floor Finish Examples | | | | | | | | | | | |
|---|---|---|---|---|---|---|---|---|---|---|---|
| Emulsion | | | | | | Wetting & Leveling Score | | | | | |
| Polymer | Floor Finish | Surfactant | Surfactant | Moles | | (After each coat) Rating 1-10 | | | | | |
| Examples | Examples | in Example | Hydrophobe | of EO | Salt Form | 1 | 2 | 3 | 4 | 5 | 6 |
| EP#1 | FF#1 (Avg. of 15)¹ | Rhodafac RS410² | Tridecyl | 3 | Na+ | 7.7 | 7.3 | 7.3 | 7.5 | 7.8 | 7.8 |
| EP#2 | FF#2 (Avg. of 3) | Rhodafac RS610 | Tridecyl | 6 | Na+ | 7 | 5.3 | 5.3 | 5.7 | 6.7 | 7 |
| EP#3 | FF#3 (Avg. of 3) | Rhodafao RS710 | Tridecyl | 10 | Na+ | 6.7 | 4.3 | 4 | 4.3 | 4.3 | 5 |
| EP#4 | FF#4 (Avg. of 3) | Rhodafac RE410 | NonylPhenol | 4 | Na+ | 7 | 6 | 6.3 | 7.3 | 7.3 | 8 |
| EP#6 | FF#6 (Avg. of 2) | Rhodafac RE610 | NonylPhenol | 9 | Na+ | 7 | 5 | 4.5 | 4.5 | 5 | 5 |
| EP#7 | FF#7 | Rhodafac RE960 | NonylPhenol | 50 | Na+ | 8 | 5 | 5 | 5 | 5 | 5 |
| EP#8 | FF#8 (Avg. of 3) | Rhodafac RS610 | Tridecyl | 6 | Free Acid | 7 | 4.7 | 4.7 | 4.3 | 4 | 4.3 |
| EP#9 | FF#9 (Avg. of 2) | Rhodafac RS710 | Tridecyl | 10 | Free Acid | 7.5 | 5.5 | 4.5 | 5.5 | 4 | 4 |
| EP#10 | FF#10 (Avg. of 2) | Rhodafac RE610 | NonylPhenol | 9 | Free Acid | 7 | 5 | 4.5 | 4.5 | 4 | 4 |
| EP#11 | FF#11 (Avg. of 3) | Rhodafac RS610 | Tridecyl | 6 | K+ | 7 | 5.3 | 5 | 6.3 | 7 | 7.3 |
| EP#12 | FF#12 (Avg. of 2) | Rhodafac RS610 | Tridecyl | 6 | Li+ | 6.5 | 5 | 4.5 | 4 | 3.5 | 4 |
| EP#13 | FF#13 (Avg. of 2) | Rhodafac RS610 | Tridecyl | 6 | NH₄+ | 6.5 | 4.5 | 4.5 | 4 | 3.5 | 4 |
| EP#14 | FF#14 (Avg. of 3) | Rhodafac RS610 | Tridecyl | 6 | TEA¹⁶ | 7.7 | 6 | 4.3 | 5.3 | 6.3 | 6.7 |
| EP#15 | FF#15 | Foamphos L-3³ | Laureth | 3 | K+ | 7 | 5 | 4 | 4 | 6 | 7 |
| EP#16 | FF#16 | Foamphos L-6 | Laureth | 6 | K+ | 7 | 5 | 5 | 5 | 5 | 5 |
| EP#17 | FF#17 | Foamphos L-9 | Laureth | 9 | K+ | 7 | 5 | 4 | 4 | 5 | 5 |
| EP#18 | FF#18 | Arlatone MAP 230K-40⁴ | C12-C13 Branched | 0 | K+ | 7 | 6 | 5 | 5 | 6 | 6 |
| EP#19 | FF#19 | Arlatone MAP 160 | Cetyl (Hexadecyl) | 0 | K+ | 7 | 5 | 4 | 4 | 5 | 5 |
| EP#20 | FF#20 | Triton QS-44⁵ | Octyl Phenol | 7.5 | K+ | 7 | 5 | 4 | 4 | 5 | 5 |
| EP#21 | FF#21 | Triton XQS-20 | Octyl Phenol | 35 | K+ | 7 | 5 | 4 | 4 | 5 | 4 |
| EP#22 | FF#22 | Tryfac 5576⁶ | 2-Ethylhexyl | 2 | K+ | 8 | 6 | 5 | 5 | 5 | 5 |
| EP#23 | FF#23 | Tryfac 5559 | C12-C15 | 5 | K+ | 7 | 5 | 4 | 4 | 5 | 5 |
| EP#24 | FF#24 | Tryfac 5553 | Isodecyl | 6 | K+ | 7 | 5 | 4 | 4 | 5 | 6 |
| EP#25 | FF#25 | Dermophos IS-2⁷ | Isostearth | 2 | K+ | 7 | 5 | 4 | 4 | 5 | 6 |
| EP#26 | FF#26 | Dermophos CT | Cetyl (Hexadecyl) | 0 | K+ | 7 | 5 | 4 | 4 | 5 | 6 |
| EP#27 | FF#27 (Avg. of 2) | Monafax 1214⁸ | Deceth | 4 | K+ | 6.5 | 5 | 4 | 4 | 4.5 | 4 |
| EP#28 | FF#28 | Monafax 1214 | Deceth | 4 | Na+ | 6 | 5 | 4 | 4 | 4 | 4 |
| EP#29 | FF#29 | Dephos 8028⁹ | Alkyl | <5 | K+ | 8 | 7 | 8 | 8 | 7 | 7 |
| EP#30 | FF#30 | Chemfac PC096¹⁰ | NonylPhenol | 6 | K+ | 6 | 4 | 3 | 3 | 3 | 4 |
| EP#31 | FF#31 | Chemfac NC096 | NonylPhenol | 6 | K+ | 6 | 4 | 3 | 3 | 3 | 4 |
| EP#33 | FF#33 | Foamphos NP-3 | NonylPhenol | 3 | Na+ | 7 | 4 | 3 | 3 | 3 | 4 |
| EP#34 | FF#34 | Foamphos NP-6 | NonylPhenol | 6 | Na+ | 6 | 4 | 3 | 3 | 3 | 4 |
| EP#35 | FF#35 | Foamphos NP-9 | NonylPhenol | 9 | Na+ | 6 | 4 | 3 | 3 | 3 | 4 |
| EP#36 | FF#36 | Dextrol OC40¹¹ | Tridecyl | 3 | Na+ | 8 | 7 | 6 | 6 | 7 | 7 |
| EP#37 | FF#37 | Dextrol OC60 | Tridecyl | 6 | Na+ | 7 | 5 | 4 | 4 | 4 | 5 |
| EP#38 | FF#38 | Dextrol OC75A | Tridecyl | 10 | Na+ | 7 | 5 | 4 | 4 | 4 | 4 |
| EP#39 | FF#39¹² | Rhodafac RS410 | Tridecyl | 3 | Na+ | 7 | 7 | 7 | 7 | 7 | 8 |
| EP#40 | FF#40¹³ | Rhodafac RS410 | Tridecyl | 3 | Na+ | 7 | 8 | 7 | 8 | 8 | 8 |
| EP#41 | FF#43¹⁴ | Rhodafac RS410 | Tridecyl | 3 | Na+ | 7 | 7 | 7 | 7 | 7 | 6 |
| EP#42 | FF#42¹⁵ | Rhodafac RS410 | Tridecyl | 3 | Na+ | 7 | 7 | 7 | 7 | 7 | 8 |

Footnotes to Table 1 1 FF#1 (Comparative Control) contained an RS410 Na⁺ surfactant level of @0.6% and a RS410 neutralization level of 0.22550% NaOH/g RS410.

2 All Rhodafac products available from Rhodia, Marietta, Ga.

3 All Foamphos products available from Alzo International, Sayreville, N.J.

4 All Arlatone products available from Uniqema, New Castle, Del.

5 All Triton products available from The Dow Chemical Company, Midland, Mich.

6 All Tryfac products available from Cognis Corp, Cincinnati, Ohio.

7 All Dermophos products available from Alzo International, Sayreville, N.J.

8 All Monafax products available from Uniqema, New Castle, Del.

9 All Dephos products available from Deforest Enterprises, Boca Raton, Fla.

10 All Chemfac products available from Chemron Corp., Paso Robles, Calif.

11 All Dextrol products available from Dexter Chemical, Bronx, N.Y.

12 FF#39 contained an RS410 Na+ surfactant level of @0.6% and a RS410 neutralization level of 0.350% NaOH/g RS410.

13 FF#40 contained an RS410 Na+ surfactant level of @0.6% and a RS410 neutralization level of 0.1550% NaOH/g RS410.

14 FF#41 contained an RS410 Na+ surfactant level of @0.3% and a RS410 neutralization level of 0.22550% NaOH/g RS410.

15 FF#42 contained an RS410 Na+ surfactant level of @0.15% and a RS410 neutralization level of 0.22550% NaOH/g RS410.

16 TEA=Triethyl amine

TABLE 2
Sulfur Based Surfactant Fluorochemical Free Floor Finish Examples

| | | | | | | Wetting & Leveling Score | | | | | | |
|---|---|---|---|---|---|---|---|---|---|---|---|---|
| Emulsion | | | | | | (After each coat) Rating 1-10 | | | | | | |
| Polymer | Floor Finish | Surfactant in | | Surfactant | Moles | Salt | | | | | | |
| Examples | Examples | Example | Surfactant Class | Hydrophobe | of EO | Form | 1 | 2 | 3 | 4 | 5 | 6 |
| EP#I | FF#1 | Rhodafac RS410 | Phosphate | Tridecyl | 3 | Na+ | 7.7 | 7.3 | 7.3 | 7.5 | 7.8 | 7.8 |
| | (Avg. of 15) | | | | | | | | | | | |
| EP#43 | FF#43 | Stepanol WA-Extra | Sulfate | Laurel | 0 | Na+ | 5 | 1 | 1 | 1 | 1 | 1 |
| EP#44 | FF#44 (Avg. of 3) | Abex JKB | Sulfate | Laurel | 12 | Na+ | 4.3 | 1 | 1 | 1 | 1.7 | 1.7 |
| EP#45 | FF#45 | Aerosol NPES930 | Sulfate | NonylPhenol | 9 | NH₄+ | 3 | 1 | 1 | 1 | 1 | 1 |
| EP#46 | FF#46 | Rhodacal DS-10 | Sulfonate | DodecylBenzene | 0 | Na+ | 5 | 1 | 3 | 3 | 3 | 3 |
| EP#47 | FF#47 | Abex 2005 | Sulfonate | C12-C15 | 9 | Na+ | 4 | 1 | 1 | 1 | 1 | 1 |
| EP#48 | FF#48 | Triton X200 | Sulfonate | AlkylAryl | yes | Na+ | 3 | 1 | 1 | 1 | 1 | 1 |
| EP#49 | FF#49 | Dowfax C10L | Diphenyl Disulfonate | DecylDiPhenyl | 0 | Na+ | 4 | 1 | 1 | 1 | 1 | 1 |
| EP#50 | FF#50 | Dowfax 2A1 | Diphenyl Disulfonate | DodecylDiPhenyl | 0 | Na+ | 5 | 1 | 1 | 1 | 1 | 1 |
| EP#51 | FF#51 | Aerosol A102 | Sulfosuccinate (Half Ester) | C12 | 4 | Na+ | 4 | 1 | 1 | 1 | 1 | 1 |
| EP#52 | FF#52 | Aerosol A103 | Sulfosuceinate (Half Ester) | NonylPhenol | 4 | Na+ | 3 | 1 | 1 | 1 | 1 | 1 |
| EP#53 | FF#53 | Aerosol OT-NY | Sulfosuecinate (Diester) | Dioctyl | 0 | Na+ | 7 | 4 | 3 | 3 | 3 | 3 |
| EP#54 | FF#54 | Gemtex 691-40 | Sulfosuccinate (Diester) | Dicyclohexyl | 0 | Na+ | 3 | 1 | 1 | 1 | 1 | 1 |

1 All Stepanol products available from The Stepan Company, Northfield, IL.
2 All Abex products available from Rhodia, Marietta, GA.
3 All Aerosol products available from Cytec Industires Inc, West Paterson. NJ.
4 All Rhodacal products available from Rhodia, Marietta, GA.
5 All Triton products available from The Dow Chemical Company, Midland, MI.
6 All Dowfax products available from The Dow Chemieal Company, Midland, MI.
7 All Gemtex products available from Finetex Inc., Spencer, NC.

By comparing the organophosphate surfactant containing fluorochemical free floor finish examples of Table 1 to the sulfur based containing fluorochemical free floor finish examples of Table 2 it is clear that the organophosphate surfactant examples have far superior wetting and leveling properties relative to the sulfur based class of surfactant examples. The wetting and leveling rating score for the organophosphate surfactant examples ranges from 6-8 (first coat) to 4-8 (sixth coat) covering a very broad range of process and compositional variables concerning organophosphate surfactant manufacture [i.e. examples prepared by both the polyphosphoric acid (FF#15-19, 25-28, 31, and 33-38) and the phosphorous pentoxide phosphating (FF#1-14, 22-24, 30, and 39-42) processes, alkyl hydrophobes ranging in hydrocarbon chain length from C8 to C18 and aromatic hydrophobes based on alkyl phenols, surfactant ethoxylation (moles EO) ranging from 0 to 50 moles EO, surfactants with either high monoester content (FF#3, 9, 15-19, 25-28, 30-31, 33-35, and 37-38) or high diester content (FF#1-2, 4-8, 10-14, 22-24, 36, and 39-42), free nonionic surfactant containing phosphate ester surfactants from 3% to 29% free nonionic surfactant (<10% FF#1, 4, 6-7, and 36) and (>10% FF#2-3, 5, 8-9, 11-14, and 37-38), free phosphoric acid and/or neutralized phosphoric acid salt(s) species containing surfactants from 0.5% to 16.5% free phosphoric acid or its salt(s) (<3% FF#1-6, 8-14, 39-42) and (>8% FF#7, 20-21)]. Conversely, only one sulfur based fluorochemical free floor finish example had a first coat rating score above 5 (FF#53, containing Aerosol OT-NV, sodium dioctyl sulfosuccinate had a first coat score of 7) while the remainder of the sulfur based examples had a first coat rating score ranging between 3-5. The sixth coat rating score for sulfur based fluorochemical free floor finish examples only reached scores ranging between 1-3 including FF#53.

### Evaluation of Fluorochemical Free Floor Finish Examples Containing Organophosphate Surfactants And Additional Surfactants

The fluorochemical free floor finish data presented below in Table 3 shows the effect of doping fluorochemical free floor finish example FF#1, which contains Rhodafac RS410 Na+ [sodium salt of polyoxyethylene (3 moles ethylene oxide, EO) tridecyl ether phosphate], with various types and levels of wetting and leveling agents. Three main classes of wetting and leveling agents have been demonstrated in Table 3; 1. an organophosphate surfactant type based on Rhodafac RS410 (FF#55-58), 2. Nonionic surfactant types based on nonionic surfactants (HLB ranging between 8.3-16.4) and several sold as superior wetting and leveling agents ( FF#59, 61-63, 65-66 HLB between 12.4-14.7), and 3. a class of additives sold as super wetting and leveling agents (FF#67-73). As shown in Table 3, adding Rhodafac RS410 as a free acid species or as a sodium salt had little effect on the wetting and leveling properties of FF#1. For the most part adding nonionic surfactants to FF#1 had a negative impact on the wetting and leveling properties of FF#1. The only nonionic surfactant that had little impact on the wetting and leveling properties of FF#1 was Tergitol TMN-6 (FF#59). All of the super wetting and leveling class of additive examples also had little effect on the wetting and leveling properties of FF#1. Consequently, the data show that other wetting and leveling agents can be combined with an organophosphate surfactant in a fluorochemical free floor finish and still achieve desirable wetting and leveling properties.

TABLE 3

| | | | | Wetting & Leveling Score | | | | | | |
|---|---|---|---|---|---|---|---|---|---|---|
| | | | | (After each coat) Rating 1-10 | | | | | | |
| Floor Finish Example FF#1 Doped with Wetting and Leveling Agent Additives | | | | % Level of | | | | | | |
| | Wetting | | | Additive | | | | | | |
| Floor | and Leveling | | | (Dry Wt/g | | | | | | |
| Finish | Agent Additive | | Moles | Floor | | | | | | |
| Examples | in Example | Type of Wetting and Leveling Agent Additive | of EO | Finish) | 1 | 2 | 3 | 4 | 5 | 6 |
| FF#1 | Rhodafac RS410 Na+ | COMPARATIVE CONTROL | 3 | X | 7.7 | 7.3 | 7.3 | 7.5 | 7.8 | 7.8 |
| (Avg. | | | | | | | | | | |
| of 15) | | | | | | | | | | |
| FF#55 | Rhodafac RS410 | Polyoxyethylene tridecyl ether phosphate - | 3 | 0.6 | 7 | 7 | 6 | 6 | 6 | 7 |
| | | Free Acid | | | | | | | | |
| FF#56 | Rhodafac RS410 Na+ | Polyoxyethylene tridecyl ether phosphate - | 3 | 0.6 | 7 | 7 | 6 | 6 | 7 | 7 |
| | | (0.15 g 50% NaOH/g RS410) | | | | | | | | |
| FF#57 | Rhodafac RS410 Na+ | Polyoxyethylene tridecyl ether phosphate - | 3 | 0.6 | 7 | 7 | 6 | 6 | 7 | 7 |
| | | (0.3 g 50% NaOH/g RS410) | | | | | | | | |
| FF#58 | Rhodafac RS410 Na+ | Polyoxyethylene tridecyl ether phosphate - | 3 | 1.2 | 8 | 7 | 7 | 7 | 7 | 7 |
| | | (0.225 g 50% NaOH/g RS410) | | | | | | | | |
| FF#59 | Tergitol TMN-6 | Trimethylnonanol Ethoxylate (Branched | 6 | 1.0 | 7 | 6 | 6 | 8 | 7 | 7 |
| | | Secondary Alcohol Ethoxylate HLB 13.1) | | | | | | | | |
| FF#60 | Tergitol 15-S-3 | C12-C14 Secondary Alcohol Ethoxylate (HLB 8.3) | 3 | 1.0 | 8 | 7 | 6 | 5 | 5 | 5 |
| FF#61 | Tergitol 15-S-7 | C12-C14 Secondary Alcohol Ethoxylate (HLB 12.4) | 7 | 1.0 | 8 | 6 | 5 | 5 | 5 | 5 |
| FF#62 | Tergitol 15-S-9 | C12-C14 Secondary Alcohol Ethoxylate (HLB 13.3) | 9 | 1.0 | 7 | 6 | 5 | 4 | 4 | 4 |
| FF#63 | Tergitol 15-S-12 | C12-C14 Secondary Alcohol Ethoxylate (HLB 14.7) | 12 | 1.0 | 7 | 6 | 4 | 3 | 3 | 3 |
| FF#64 | Tergitol 15-S-20 | C12-C14 Secondary Alcohol Ethoxylate (HLB 16.4) | 20 | 1.0 | 7 | 6 | 5 | 4 | 4 | 4 |
| FF#65 | Tergitol NP-9.5 | Primary Nonyl Phenol Alcohol Ethoxylate (HLB 13.1) | 9.5 | 1.0 | 7 | 6 | 4 | 3 | 3 | 3 |
| FF#66 | Neodol 91-6 | C9-C11 Linear Primary Alcohol Ethoxylate (HLB 12.5) | 6 | 1.0 | 7 | 6 | 4 | 4 | 4 | 4 |
| FF#67 | Silwet L-77 | Polyalkyleneoxide modified Heptamethyltrisiloxane | | 0.1 | 7 | 8 | 7 | 7 | 9 | 9 |
| FF#68 | Silwet L-7608 | Polyalkyleneoxide modified Heptamethyltrisiloxane | | 0.1 | 7 | 8 | 8 | 8 | 9 | 9 |
| FF#69 | Dynol 604 | Acetylene-based, proprietary | | 0.1 | 7 | 8 | 8 | 8 | 8 | 9 |
| FF#70 | Tegoglide 440 | Polyether modified polysiloxane | | 0.1 | 6 | 6 | 7 | 8 | 8 | 8 |
| FF#71 | Byk 347 | Polyether modified polysiloxane | | 0.1 | 7 | 8 | 7 | 8 | 9 | 9 |
| FF#72 | Lambent MFF-199SW | Silicone copolyol (Nonionic) | | 0.1 | 7 | 8 | 7 | 8 | 9 | 9 |
| FF#73 | Polyfox TM1 | Proprietary (Fluorochemical Surfactant) | | 0.1 | 7 | 7 | 7 | 7 | 9 | 8 |

1 All Tergitol products available from The Dow Chemical Company, Midland, MI.
2 All Neodol products available from Tomah Products, Milton, WI.
3 All Silwet products available from OSI Specialties, Greenwich, CT.
4 All Dynol products available from Air Products, Allentown, PA.
5 All Tegoglide products available from Degussa Goldschmidt, Hopewell, VA.
6 All Byk products available from Byk-Chemie, USA, Wallingford, CT.
7 All Lambent products available from Lambent Technologies, Northcross, GA.
8 All Polyfox products available from Omnova Solutions, Akron, OH.

### Comparative Example: Evaluation of Fluorochemical Free Floor Finish Examples Containing Sulfur-based Surfactants And Additional Surfactants

The fluorochemical free floor finish example data presented in Table 4 show the effects of doping fluorochemical free floor finish examples containing sulfur based surfactant with various types and levels of wetting and leveling agents. Five main classes of wetting and leveling agents have been demonstrated in Table 4: 1. an organophosphate surfactant type based on Rhodafac RS410 (Free Acid FF#77 and Sodium Salts FF#76, 78-83); 2. two fluorochemical surfactants based on Zonyl FSE (FF#84) from DuPont, Wilmington, Del. and, Polyfox TM1 (FF#85) from Omnova Solutions, Akron, Ohio; 3. two nonionic surfactant types sold as superior wetting and leveling agents ( FF#86 based on Tergitol TMN-6 HLB 13.1 and FF#87 based on Tergitol 15-S-9 HLB 13.3); 4. a sulfosuccinate based anionic surfactant which is sold as a superior wetting and leveling agent based on Aerosol OT-NV (FF#88 sodium dioctyl sulfosuccinate); and 5. a class of additives sold as super wetting and leveling agents (FF#89-94).

The organophosphate surfactant Rhodafac RS410 was added to various fluorochemical free floor finishes containing sulfur based surfactants as follows. In fluorochemical free floor finish examples FF#76, 79-83, Rhodafac RS410 sodium salt (0.350% NaOH/g RS410) was doped into sulfur based surfactant containing fluorochemical free floor finish examples FF#43-44, 46, 50-51, and 53 at a 0.6 dry wt %/g of floor finish. In fluorochemical free floor finish examples FF#77 and FF#78, Rhodafac RS410 was doped into sulfur based surfactant containing fluorochemical free floor finish example FF#44 at a 0.6 dry wt %/g of floor finish as a free acid species and as a sodium salt (0.1550% NaOH/g RS410), respectively. The Rhodafac RS410 sodium salt doping was carried out on sulfur based surfactant containing fluorochemical free floor finish examples FF#43 (containing Stepanol WA-Extra), FF#44 (containing Abex JKB), FF#46 (containing Rhodacal DS-10), FF#50 (containing Dowfax 2 A1), FF#51 (containing Aerosol A102), and FF#53 (containing Aerosol OT-NV). The Rhodafac RS410 doped into these sulfur based surfactant containing fluorochemical free floor finish examples FF#76-83 dramatically improved the wetting and leveling properties of these sulfur based surfactant containing fluorochemical free floor finish examples.

The remainder of the examples in Table 4 (FF#84-94) were prepared by doping the sulfur based surfactant containing fluorochemical free floor finish example FF#44 (containing Abex JKB) with various wetting and leveling agents. The fluorochemical surfactants Zonyl FSE (FF#84) and Polyfox TM1 (FF#85) added to FF#44 at a 0.01% loading and at a 0.1% wt % of floor finish, respectively, improved the wetting and leveling properties of FF#44. The two nonionic surfactants (FF#86 & FF#87) were added to FF#44 at a 1% loading but yielded very meager improvements in the wetting and leveling properties of FF#44. The Aerosol OT-NV (FF#88) added to FF#44 at a 1% loading also yielded very meager improvements in the wetting and leveling properties of FF#44. The additives sold as super wetting and leveling agents (FF#89-94) were added to FF#44 at a 0.1 wt % and also failed to provide much improvement in the wetting and leveling properties of FF#44. Consequently, the data in Table 4 demonstrate that organophosphate surfactants such as Rhodafac RS410 are uniquely effective wetting agents for the preparation of fluorochemical free aqueous coating compositions having very good to good wetting and leveling properties.

TABLE 4

| Floor Finish Examples Prepared from Emulsion Polymers Containing Sulfur-Based Emulsifiers | | | | | | | | | |
|---|---|---|---|---|---|---|---|---|---|
| and Doped with Various Wetting and Leveling Agent Additives | | | | | | | | | |
| | | | % Level of | | | | | | |
| | | | Additive | | | | | | |
| Floor | Sulfur-Based Surfactant Floor Finish | | (Dry Wt/g | Wetting & Leveling Score | | | | | |
| Finish | Compositions Used for Wetting and | Type of Wetting and | Floor | (After each coat) Rating 1-10 | | | | | |
| Examples | Leveling Agent Additive Doping Examples | Leveling Agent Additive | Finish) | 1 | 2 | 3 | 4 | 5 | 6 |
| FF#1 | Rhodafac RS410 Na+ | COMPARATIVE CONTROL | X | 7.7 | 7.3 | 7.3 | 7.5 | 7.8 | 7.8 |
| (avg. | | | | | | | | | |
| of 15) | | | | | | | | | |
| FF#76 | FF#43 Na Lauryl Sulfate | Rhodafac RS410-Na salt | 0.6 | 7 | 6 | 6 | 6 | 5 | 5 |
| | (Stepanol WA-Extra) | (0.3 g 50% NaOH/g RS410) | | | | | | | |
| FF#77 | FF#44 Na C12 (12EO) Sulfate (Abex JKB) | Rhodafac RS410-Na salt | 0.6 | 7 | 5 | 4 | 5 | 6 | 6 |
| | | (Free Acid) | | | | | | | |
| FF#78 | FF#44 Na C12 (12EO) Sulfate (Abex JKB) | Rhodafac RS410-Na salt | 0.6 | 7 | 5 | 4 | 5 | 6 | 6 |
| | | (0.15 g 50% NaOH/g RS410) | | | | | | | |
| FF#79 | FF#44 Na C12 (12EO) Sulfate (Abex JKB) | Rhodafac RS410-Na salt | 0.6 | 7 | 5 | 6 | 6 | 6 | 7 |
| | | (0.3 g 50% NaOH/g RS410) | | | | | | | |
| FF#80 | FF#46 Na Dodecylbenzene Sulfonate | Rhodafac RS410-Na salt | 0.6 | 7 | 7 | 7 | 8 | 7 | 7 |
| | (Rhodacal DS-10) | (0.3 g 50% NaOH/g RS410) | | | | | | | |
| FF#81 | FF#50 Di-Na Dodecyl Diphenyloxide | Rhodafac RS410-Na salt | 0.6 | 7 | 6 | 4 | 5 | 5 | 5 |
| | Disulfonate (Dowfax 2A1) | (0.3 g 50% NaOH/g RS410) | | | | | | | |
| FF#82 | FF#51 Ethoxylated (4 EO) lauryl alcohol | Rhodafac RS410-Na salt | 0.6 | 7 | 6 | 5 | 5 | 5 | 5 |
| | half ester of Di-Na sulfosuccinic acid | (0.3 g 50% NaOH/g RS410) | | | | | | | |
| | (Aerosol A102) | | | | | | | | |
| FF#83 | FF#53 Dioctylester of Na sulfosuccinic | Rhodafac RS410-Na salt | 0.6 | 8 | 7 | 7 | 8 | 7 | 7 |
| | acid (Aerosol OT-NV) | (0.3 g 50% NaOH/g RS410) | | | | | | | |
| FF#84 | FF#44 Na C12 (12EO) Sulfate (Abex JKB) | Zonyl FSE (Fluorochemical | 0.01 | 6 | 8 | 8 | 8 | 8 | 9 |
| | | Surfactant)¹ | | | | | | | |
| FF#85 | FF#44 Na C12 (12EO) Sulfate (Abex JKB) | Polyfox TM1 (Fluorochemical | 0.1 | 6 | 7 | 7 | 5 | 6 | 5 |
| | | Surfactant)² | | | | | | | |
| FF#86 | FF#44 Na C12 (12EO) Sulfate (Abex JKB) | Tergitol TMN-6 | 1.0 | 5 | 3 | 3 | 2 | 2 | 2 |
| FF#87 | FF#44 Na C12 (12EO) Sulfate (Abex JKB) | Tergiotol 15-S-9 | 1.0 | 5 | 3 | 3 | 2 | 2 | 2 |
| FF#88 | FF#44 Na C12 (12EO) Sulfate (Abex JKB) | Aerosol OT-NV | 1.0 | 8 | 7 | 5 | 4 | 3 | 3 |
| FF#89 | FF#44 Na C12 (12EO) Sulfate (Abex JKB) | Silwet L-77 | 0.1 | 5 | 5 | 3 | 3 | 3 | 3 |
| FF#90 | FF#44 Na C12 (12EO) Sulfate (Abex JKB) | Silwet L-7608 | 0.1 | 5 | 5 | 6 | 4 | 3 | 3 |
| FF#91 | FF#44 Na C12 (12EO) Sulfate (Abex JKB) | Dynol 604 | 0.1 | 5 | 3 | 3 | 2 | 2 | 2 |
| FF#92 | FF#44 Na C12 (12EO) Sulfate (Abex JKB) | Tegoglide 440 | 0.1 | 5 | 3 | 3 | 2 | 2 | 2 |
| FF#93 | FF#44 Na C12 (12EO) Sulfate (Abex JKB) | Byk 347 | 0.1 | 5 | 3 | 3 | 2 | 3 | 3 |
| FF#94 | FF#44 Na C12 (12EO) Sulfate (Abex JKB) | Lambent MFF-199SW | 0.1 | 5 | 3 | 3 | 2 | 2 | 2 |

¹All Zonyl products available from DuPont, Wilmington, DE.
²All Polyfox products available from Omnova Solutions. Akron, OH.

### Evaluation of Static Surface Tension Exhibited By Fluorochemical Free Floor Finish Examples Containing Organophosphate Surfactants

Static surface tension measurements were carried out on a number of fluorochemical free floor finish examples as well as FF#84, which contains fluorochemical surfactant Zonyl FSE, using a Kruss Processor Tensiometer model K12 from Kruss USA, Charlotte, N.C. It is important to control the surface tension of the floor finish composition in order to produce floor finish coatings with desirable wetting and leveling properties. Additionally, suppliers of wetting and leveling agents market and sell their products based on data showing that their wetting and leveling agents effectively reduce surface tension which will yield floor finish coatings with desirable wetting and leveling properties. As an approximate guide, static surface tension of a floor finish compositions must be below 32 dynes/centimeter (cm) in order to achieve desirable wetting and leveling properties.

For example, floor finish composition FF#84 containing an industrial standard fluorochemical surfactant wetting and leveling agent (0.01% Zonyl FSE) yields a surface tension of 27.32 dynes/cm and produces a floor finish composition with very good to good wetting and leveling properties. Conversely, the same floor finish composition without any Zonyl FSE (FF#44) yields a surface tension of 31.64 dynes/cm and produces a floor finish composition with very poor to poor wetting and leveling properties. For comparision fluorochemical free floor finish example FF#1, containing Rhodafac RS410 sodium salt (polyoxyethylene (3 moles ethylene oxide, EO) tridecyl ether phosphate) and used as the organophosphate surfactant comparative control in the examples, yields a surface tension of 28.77 dynes/cm and produces a floor finish composition with very good to good wetting and leveling properties. These examples indicate a trend that lower floor finish surface tension result in desirable wetting and leveling properties.

Although this correlation seems logical, alone it is insufficient for predicting whether a floor finish will have good wetting and leveling properties. To demonstrate this point, floor finish composition FF#84 containing an industrial standard fluorochemical surfactant wetting and leveling agent (0.01% Zonyl FSE) yields a surface tension of 27.32 dynes/cm and produces a floor finish composition with very good to good wetting and leveling properties but fluorochemical free floor finish examples FF#1-2, 15, and 29 all have surface tension values above FF#1 (range from 28.69 to 29.66 dynes/cm) but yet display good to very good wetting and leveling properties. In contrast, sulfur based fluorochemical free floor finish examples FF#45-52 all have surface tension values (27.97 to 29.81 dynes/cm) similar to those of fluorochemical free floor aqueous coating examples FF#1-2, 15, and 29. However, FF#45-52 have very poor to poor wetting and leveling properties whereas FF#1-2, 15, and 29 have good to very good wetting and leveling properties. Consequently, the standard correlation that lower surface tension yields good wetting and leveling properties does not apply entirely to this data. In fact, the surface tension/wetting and leveling physical property relationship data illustrated in Table 5 supports the surprising and unexpected result that organophosphate surfactants yield fluorochemical free aqueous coating compositions with desirable wetting and leveling characteristics.

TABLE 5

| Surface Tension Measurements and Wetting and | | | | | | | | |
|---|---|---|---|---|---|---|---|---|
| Leveling Scoring Data of Floor Finish Examples | | | | | | | | |
| | | Surface Tension | Wetting & Leveling Score | | | | | |
| Floor Finish | Surfactants in | Measurement | (After each coat) Rating 1-10 | | | | | |
| Examples | Floor Finish Examples | (Dynes/cm) | 1 | 2 | 3 | 4 | 5 | 6 |
| FF#84 | FF#44 (Abex JKB Na+) + | 27.32 | 6 | 8 | 8 | 8 | 8 | 9 |
| | 0.01% Zonyl FSE | | | | | | | |
| FF#44 (Avg. of 3) | FF#44 (Abex JKB Na+) | 31.64 | 4.3 | 1 | 1 | 1 | 1.7 | 1.7 |
| FF#1 (Avg. of 15) | Rhodafac RS410 Na+ | 28.77 | 7.7 | 7.3 | 7.3 | 7.5 | 7.8 | 7.8 |
| FF#2 (Avg. of 3) | Rhodafac RS610 Na+ | 29.01 | 7 | 5.3 | 5.3 | 5.7 | 6.7 | 7 |
| FF#3 (Avg. of 3) | Rhodafac RS710 Na+ | 29.40 | 6.7 | 4.3 | 4 | 4.3 | 4.3 | 5 |
| FF#45 | Aerosol NPES930 NH4+ | 29.71 | 3 | 1 | 1 | 1 | 1 | 1 |
| FF#46 | Rhodacal DS-10 Na+ | 27.97 | 5 | 1 | 3 | 3 | 3 | 3 |
| FF#47 | Abex 2005 Na+ | 28.42 | 4 | 1 | 1 | 1 | 1 | 1 |
| FF#48 | Triton X200 Na+ | 29.13 | 3 | 1 | 1 | 1 | 1 | 1 |
| FF#49 | Dowfax C10L Na+ | 28.75 | 4 | 1 | 1 | 1 | 1 | 1 |
| FF#50 | Dowfax 2A1 Na+ | 28.79 | 5 | 1 | 1 | 1 | 1 | 1 |
| FF#51 | Aerosol A102 Na+ | 29.61 | 4 | 1 | 1 | 1 | 1 | 1 |
| FF#52 | Aerosol A103 Na+ | 29.81 | 3 | 1 | 1 | 1 | 1 | 1 |
| FF#15 | Foamphos L-3 K+ | 29.66 | 7 | 5 | 4 | 4 | 6 | 7 |
| FF#29 | Dephos 8028 K+ | 28.82 | 8 | 7 | 8 | 8 | 7 | 7 |

### Evaluation of Fluorochemical Free Floor Finish Examples Containing A Phosphate Containing Polymer

Phosphate monomer-containing polymers (EP#5 5-64) were synthesized following the procedure for EP#1 above except that 14 g of either Sipomer PAM 100 [phosphate esters of polyethylene glycol (PEG) monomethacrylate] or Sipomer PAM 200 [phosphate esters of polypropylene glycol (PPG) monomethacrylate] both from Rhodia Inc., Cranbury, N.J. were incorporated into the emulsion polymerization. The PAM phosphate monomers were incorporated into the emulsion polymer examples as free acid species [both PAM monomers have an acid number between 100-120 (at first inflection point pH @5.5) and are high in monoester content].

Two types of emulsion polymers were synthesized using the PAM phosphate monomers. The PAM monomer was incorporated into the emulsion polymer composition as a one-stage process (Emulsion Polymer Examples EP#57-58 and EP#63-64) or as a seeded two-stage process (Emulsion Polymer Examples EP#55-56 and EP#59-62). The one-stage process was an exact duplication of the process used to make EP#1 except an additional 14 g of PAM phosphate monomer was added to the monomer mixture of styrene, butyl acrylate, methyl methacrylate, alpha methyl styrene, and methacrylic acid before the polymerization commenced. The two-stage process consisted of preparing a seed emulsion polymer (first-stage) that contained 14 g of PAM phosphate monomer and 10% (35 g of monomer mixture) of the monomer mixture used in emulsion polymer example EP#1. In the two-stage process, after the seed emulsion polymer was formed (first-stage) the remaining 90% (315 g of monomer mixture) of the monomer mixture used in emulsion polymer example EP#1 was added over 60 minutes at 85° C. to complete the second-stage polymer (completion of the two-stage polymer). Also, two separate surfactants were used to make emulsion polymer examples EP#55-64. Emulsion polymer examples EP#55-60 used 7 g dry weight Abex 2005 sulfonate surfactant to prepare these emulsion polymer examples and EP#61-64 used 14 g dry weight Rhodafac RS-410 Na+ (formed from 0.225 of 50% NaOH/g RS410) to prepare these emulsion polymer examples (as used in EP#1).

When these emulsion polymer examples were converted into fluorochemical free floor finish examples the amount of PAM phosphate monomer, Abex 2005, and RS-410 Na+ based on floor finish composition resulted in finish examples containing 0.5% PAM phosphate monomer and either 0.25% Abex 2005 or 0.6% RS-410 Na+. Additionally, all emulsion polymer examples were post emulsion polymerization neutralized with either ammonium hydroxide or KOH to make the resulting salt of the free acid phosphate PAM monomer moiety. Emulsion polymer examples EP#55-58 and EP#61-64 were ammonium salts of PAM phosphate monomer moieties and EP#59-60 were potassium salts of the PAM phosphate monomer moieties. The resulting emulsion polymers were then incorporated into the standard floor finish formulation following floor finish FF#1 as a model example. The results show that phosphate monomer-containing emulsion polymers can yield major improvements in the wetting and leveling properties of sulfur based surfactant containing fluorochemical free floor finish compositions such as shown by floor finish examples FF#97-102. Also, floor finish examples FF#103-106 demonstrate that floor finishes containing organophosphate surfactants and phosphate monomer-containing polymers can yield fluorochemical free floor finish compositions with good to very good wetting and leveling properties. These floor finish examples FF#97-106 can be found in Table 6.

TABLE 6

| Phosphate Monomer Containing Fluorochemical Free Floor Finish Examples | | | | | | | | | | | | | |
|---|---|---|---|---|---|---|---|---|---|---|---|---|---|
| | | | % Level of | | % Level | | | | | | | | |
| | | | Surfactant | | of PAM | Phosphate | | | | | | | |
| Emulsion | Floor | | (Dry Wt/g | Phosphate | Monomer | Monomer | Phosphate | Wetting & Leveling Score | | | | | |
| Polymer | Finish | Surfactant | Floor | Monomer | (Dry Wt/g | Polymerization | Monomer | (After each coat) Rating 1-10 | | | | | |
| Examples | Examples | in Example | Finish) | in Example | Floor Finish) | Staging | Salt Form | 1 | 2 | 3 | 4 | 5 | 6 |
| EP#1 | FF#1 | RS410 Na+ | 0.6 | Comparative Control | | | | 7.7 | 7.3 | 7.3 | 7.5 | 7.8 | 7.8 |
| EP#55 | FF#97 | Abex 2005 | 0.25 | PAM 100 | 0.5 | 2-Stage | NH₄+ | 7 | 6 | 6 | 7 | 7 | 6 |
| EP#56 | FF#98 | Abex 2005 | 0.25 | PAM 200 | 0.5 | 2-Stage | NH₄+ | 7 | 6 | 6 | 5.5 | 6 | 5.5 |
| EP#57 | FF#99 | Abex 2005 | 0.25 | PAM 100 | 0.5 | 1-Stage | NH₄+ | 7 | 6 | 6 | 6.5 | 7 | 6 |
| EP#58 | FF#100 | Abex 2005 | 0.25 | PAM 200 | 0.5 | 1-Stage | NH₄+ | 7 | 6 | 6 | 6 | 7 | 6.5 |
| EP#59 | FF#101 | Abex 2005 | 0.25 | PAM 100 | 0.5 | 2-Stage | K+ | 7 | 6 | 6 | 6 | 6.5 | 5.5 |
| EP#60 | FF#102 | Abex 2005 | 0.25 | PAM 200 | 0.5 | 2-Stage | K+ | 7 | 6 | 6 | 5 | 6 | 5 |
| EP#61 | FF#103 | RS410 Na+ | 0.6 | PAM 100 | 0.5 | 2-Stage | NH₄+ | 7 | 7 | 1 | 8 | 8 | 7 |
| EP#62 | FF#104 | RS410 Na+ | 0.6 | PAM 200 | 0.5 | 2-Stage | NH₄+ | 8 | 8 | 1 | 7 | 7 | 7 |
| EP#63 | FF#105 | RS410 Na+ | 0.6 | PAM 100 | 0.5 | 1-Stage | NH₄+ | 7 | 8 | 7 | 7 | 8 | 8 |
| EP#64 | FF#106 | RS410 Na+ | 0.6 | PAM 200 | 0.5 | 1-Stage | NH₄+ | 7 | 8 | 8 | 7 | 8 | 8 |

### Evaluation of Fluorochemical Free And Zinc Free Floor Finish Examples

Fluorochemical and zinc free floor finish examples (FF#107-108) were prepared to demonstrate that good wetting and leveling properties can be achieved from floor finish examples without zinc and without zinc but containing an alternative metal such as calcium. Floor finish example FF#107 was prepared as an exact duplication of FF#1 except the zinc ammonium carbonate (5.3 was eliminated from the formula to produce a zinc free example. Floor finish example FF#108 was prepared by taking Emulsion Polymer Example EP#1 and reacting the emulsion polymer with Ca(OH)2 (0.0045 Ca(OH) 2/ g Emulsion Polymer Example EP#1). The resulting calcium modified emulsion polymer EP#65 was then incorporated into a floor finish using FF#1 as a model example except that the zinc ammonium carbonate was eliminated from the formula to produce a zinc free example as done for FF#107. The results indicate that both FF#107 (zinc free FF#1) and FF#108 (zinc free but contains calcium) produce fluorochemical and zinc free floor finishes that result in good wetting and leveling characteristics. These fluorochemical and zinc free floor finish examples can be found in Table 7.

TABLE 7

| Fluorochemical and Zinc Free | | | | | | | |
|---|---|---|---|---|---|---|---|
| Floor Finish Examples | | | | | | | |
| Floor | | Wetting & Leveling Score | | | | | |
| Finish | | (After each coat) Rating 1-10 | | | | | |
| Examples | Floor Finish Composition | 1 | 2 | 3 | 4 | 5 | 6 |
| FF#1 | COMPARATIVE CONTROL | 7.7 | 7.3 | 7.3 | 7.5 | 7.8 | 7.8 |
| FF#107 | Zinc Free Version of FF#1 | 7 | 7 | 6.5 | 7 | 7 | 9 |
| FF#108 | Zinc Free but Calcium | 7 | 7 | 7 | 7 | 8 | 9 |
| | Containing Version of | | | | | | |
| | FF#1 using EP#65 | | | | | | |

### Evaluation of Fluorochemical Free Floor Finish Examples Containing A Polyurethane And Organophosphate Surfactant

Fluorochemical free floor finish examples containing a polyurethane polymer were prepared as follows. Fluorochemical free floor finish example FF#109 was prepared by making a 80:20 dry weight-on-weight blend of floor finish example FF#1 (80%) and Sancure 825 (20%) [an aqueous polyurethane dispersion] to produce a 20% non-volatile floor finish composition. Fluorochemical free floor finish example FF#110 was prepared by making a 99.4:0.6 dry weight-on-weight blend of Sancure 825 (99.4%) [an aqueous polyurethane dispersion] and Rhodafac RS-410 Na+ (0.6%) [formed from 0.225 of 50% NaOH/g RS410] to produce a 20% nonvolatile floor finish composition. The results show that fluorochemical free and polyurethane containing floor finishes which also contain organophosphate surfactants can produce coatings with good wetting and leveling properties. These fluorochemical free floor finish examples containing polyurethane and organophosphate surfactant can be found in Table

TABLE 8

| Fluorochemical Free Polyurethane | | | | | | | |
|---|---|---|---|---|---|---|---|
| and Organophosphate Surfactant | | | | | | | |
| Containing Floor Finish Examples | | | | | | | |
| Floor | | Wetting & Leveling Score | | | | | |
| Finish | | (After each coat) Rating 1-10 | | | | | |
| Examples | Floor Finish Composition | 1 | 2 | 3 | 4 | 5 | 6 |
| FF#1 | COMPARATIVE EXAMPLE | 7.7 | 7.3 | 7.3 | 7.5 | 7.8 | 7.8 |
| FF#109 | 80% FF#1:20% Sancure 825¹ | 7.5 | 8 | 9 | 9 | 8.5 | 9 |
| FF#110 | 99.4% Sancure 825:0.6% | 7 | 7 | 7 | 7 | 7.5 | 8 |
| | RS410Na+ | | | | | | |

¹Sancure 825 is an aliphatic polyester dispersion from Noveon Inc, Cleveland, OH

While various embodiments have been illustrated and described, it should be understood that changes and modifications can be made therein in accordance with one of ordinary skill in the art without departing from the invention in its broader aspects. Various features of the invention are defined in the following claims.

1. An aqueous coating composition comprising a film-forming polymer and an organophosphate surfactant, wherein the organophosphate surfactant comprises an ionizable phosphate group and a hydrophobe, and the aqueous coating composition is free of fluorochemical su rfactant and poly(oxy-1,2-ethanediyl), α-(nonylphenyl)-ω-hydroxy-phosphate having about 6 moles of ethoxylation per mole of nonylphenyl group.

2. The composition of claim 1 wherein the organophosphate surfactant is about 0.001 aboutby weight of the aqueous coating composition.

3. The composition of claim 1 wherein the organophosphate surfactant is about 0.01 about by weight of the aqueous coating composition.

4. The composition of claim 1 wherein 10 to 100 wt % of the organophosphate surfactant exists as a neutralized salt.

5. The composition of claim 1 wherein the hydrophobe is a non-phenolic hydrophobe.

6. The composition of claim 1 wherein the hydrophobe is a substituted or unsubstituted alkyl having 1 40 carbon atoms.

7. The composition of claim 1 wherein the hydrophobe is a substituted or unsubstituted aryl or substituted or unsubstituted arylalkyl.

8. The composition of claim 7 wherein the aryl or arylalkyl has 6 carbon atoms.

9. The composition of claim 1 wherein the organophosphate surfactant contains up to 50 equivalents of alkoxylation.

10. The composition of claim 1 wherein the organophosphate surfactant has a diester content of up to about 80 wt %.

11. The composition of claim 1 wherein the organophosphate surfactant has a diester content of up to about 60 wt %.

12. The composition of claim 1 wherein the organophosphate surfactant has a monoester content of up to about 100 wt %.

13. The composition of claim 1 wherein the film-forming polymer is an acrylic, vinyl, or vinyl/acrylic emulsion polymer, or a mixture of two or more thereof.

14. The composition of claim 1 wherein the film-forming polymer is a vinyl/acrylic emulsion polymer.

15. The composition of claim 13 wherein the vinyl/acrylic emulsion polymer is a styrene/acrylic emulsion polymer.

16. The composition of claim 1 wherein the film-forming polymer comprises polymerized phosphate-containing monomers.

17. The composition of claim 1 wherein the film-forming polymer is a urethane polymer or a mixture of urethane and acrylic, vinyl, or vinyl/acrylic emulsion polymers.

18. The composition of claim 1 further comprising one or more additives selected from the group consisting of surfactants, polymeric emulsifying agents, coalescing aids, wetting aids, leveling aids, ionic crosslinking agents, wax dispersions and emulsions, defoamers and antifoamers, antistatic agents, and biocides.

19. The composition of claim 1 further comprising a wetting aid or leveling aid selected from the group consisting of anionic surfactants, cationic surfactants, nonionic surfactants, polymeric emulsifying agents, and mixtures of two or more thereof.

20. The composition of claim 1 further comprising an ionic crosslinking agent selected from the group consisting of metals, metal complexes, or mixtures of two or more thereof.

21. The composition of claim 1 further comprising a coalescing aid selected from the group consisting of organic solvents, plasticizers, and mixtures of two or more thereof.

22. The composition of claim 1 comprising
0.001 to 10 wt % organophosphate surfactant(s);
0.1 to 70 wt % film-forming polymer;
30 to 99 wt % water;
up to 3 wt % ionic crosslinking agent(s);
up to 2 wt % surfactant(s) other than organophosphate surfactant;
up to 40 wt % polymeric emulsifying agent(s);
up to 35 wt % coalescing agent(s); and
up to 40 wt % wax(es);
based on the total weight of the composition.

23. The composition of claim 1 which is zinc free.

24. A method of making the aqueous coating composition of claim 1, the method comprising forming the film-forming polymer in the presence of the organophosphate surfactant.

25. The method of claim 24 further comprising mixing the filmpolymer and organophosphate surfactant with one or more additives selected from the group consisting of surfactants, polymeric emulsifying agents, coalescing aids, wetting aids, leveling aids, ionic crosslinking agents, wax dispersions and emulsions, defoamers and antifoamers, antistatic agents, and biocides.

26. A method of making the aqueous coating composition of claim 1, the method comprising mixing the film-forming polymer with the organophosphate surfactant.

27. An aqueous coating composition comprising a film-forming polymer and an organophosphate surfactant, wherein the organophosphate surfactant comprises an ionizable phosphate group and a non-phenolic hydrophobe.

28. An aqueous coating composition comprising a film-forming polymer that comprises polymerized phosphatemonomers, wherein the aqueous coating composition is free of fluorochemical surfactant.

29. The composition of claim 28 wherein the phosphate-containing monomers are selected from the group consisting of phosphate esters of polyethylene glycol monomethacrylate and phosphate esters of polypropylene glycol monomethacrylate.

30. An aqueous coating composition comprising a film-forming polymer and one or more additives selected from the group consisting of surfactants, polymeric emulsifying agents, coalescing aids, wetting aids, leveling aids, ionic crosslinking agents, wax dispersions and emulsions, defoamers and antifoamers, antistatic agents, and biocides, wherein the film-forming polymer comprises polymerized phosphatemonomers.

31. A method of polishing a surface, the method comprising applying to a surface the aqueous coating composition of claim 1.

32. The method of claim 31 wherein the surface is a floor, wall, ceiling, countertop, or bathroom surface.

33. The method of claim 31, further comprising applying one or more additional coats of the aqueous coating composition of claim 1.

34. A coating produced by the method of claim 31.

35. A finished surface comprising a surface and a coating produced by the method of claim 31.

36. A method of polishing a surface, the method comprising applying to a surface the aqueous coating composition of claim 30.
